(19) United States
(12) Patent Application Publication
(10) Pub. No.: US 2022/0337138 A1
(43) Pub. Date: Oct. 20, 2022

(54) METHOD FOR PRODUCING A ROTOR FOR AN ELECTRIC MACHINE AND CORRESPONDING ROTOR AND CORRESPONDING ELECTRIC

(71) Applicant: Schaeffler Technologies AG & Co. KG, Herzogenaurach (DE)

(72) Inventors: Andreas KESKINOGLU, Freiburg (DE); Alexandre FISCHER, Strasbourg (FR)

(73) Assignee: Schaeffler Technologies AG & Co. KG, Herzogenaurach (DE)

(21) Appl. No.: 17/636,051

(22) PCT Filed: Jul. 22, 2020
(86) PCT No.: PCT/DE2020/100640

§ 371 Date: Feb. 17, 2022

(30) Foreign Application Priority Data
Aug. 21, 2019 (DE) 10 2019 122 507.8

(51) Int. Cl. H02K 15/03; H02K 1/27; H02K 7/00

(52) U.S. Cl. CPC H02K 15/03; H02K 1/27; H02K 7/003

(57) ABSTRACT

A method for producing a rotor (10) for an electric machine, in which the rotor (10) includes a rotor shaft (14), a ferromagnetic main body (20) or a row of ferromagnetic main bodies (20) mounted axially successively on the rotor shaft (14), a disc element (16) mounted on the rotor shaft (14), which connects axially to the main body (20) or one of the main bodies (20), and at least one permanent magnet (26). At least one cavity (24) is formed in the main body(ies) (20), and the magnet (26) is arranged in and glued into the cavity (24). The disc element (16) is mounted on the rotor shaft (14) by a jointing process and the main body(ies) (20) are mounted on the rotor shaft (14) by a jointing process and only after the corresponding main body (20) is mounted is the associated permanent magnet (26) arranged and glued into the at least one cavity (24).

### CROSS-REFERENCE TO RELATED APPLICATIONS

This application is the U.S. National Phase of PCT Appln. No. PCT/DE2020/100640, filed Jul. 22, 2020, which claims priority from German Patent Application No. 10 2019 122 507.8, filed Aug. 21, 2019, the entire disclosures of which are incorporated by reference herein.

### TECHNICAL FIELD

The disclosure relates to a method for producing a rotor for an electric machine, in particular a permanently excited synchronous machine, wherein the rotor comprises the following components: (i) an axially extending rotor shaft, (ii) a ferromagnetic main body mounted on the rotor shaft or a series of ferromagnetic base bodies mounted axially successively on the rotor shaft, (iii) a disc element mounted on the rotor shaft which connects axially to the main body or one of the main bodies and (iv) at least one permanent magnet, wherein at least one cavity is formed in the at least one main body and wherein the at least one permanent magnet is arranged in and glued into the at least one cavity.

The disclosure further relates to a corresponding rotor and a corresponding electric machine.

### BACKGROUND

Permanently excited synchronous machines (PSM) are used in many industrial applications and increasingly also in automotive applications. The built-in laminated rotor cores are usually preassembled. The magnets are joined and glued into the laminated rotor cores. The laminated rotor cores are finally pressed onto the rotor shaft as components ready for installation.

The permanent magnets or their adhesives experience high loads over their lifetime due to the high speed/performance requirements. In order to meet these requirements, the adhesive must be applied evenly to the adhesion surfaces between the laminated rotor core and the magnet in order to fix the magnet over its service life. During assembly, it may occur that the adhesive does not completely penetrate into the adhesive gap or, conversely, emerges again on the opposite side of the laminated rotor core. Unwanted leakage of the adhesive must be avoided at all costs.

Document DE 10 2008 027 758 A1 describes a method for producing a rotor for a dynamo-electric machine, wherein the rotor comprises the following components: (i) an axially extending rotor shaft, (ii) a ferromagnetic main body mounted on the rotor shaft in the form of a laminated core, (iii) two disc elements mounted on the rotor shaft, which elements connect axially to the main body on one side each, and (iv) a plurality of permanent magnets, wherein a plurality of cavities designated as magnet pockets is formed in the main body, and wherein the permanent magnets are arranged in the cavities and cast there. For this purpose, the disc elements have distribution channels for a corresponding casting compound with breakout openings to the outside. After the permanent magnets have been placed in the magnet pockets, they are added to disc elements and the laminated core, and disc elements are fixed by means of bolts.

### SUMMARY

It is the object of the disclosure to specify measures by which the permanent magnets are/will be permanently fixed in the main body of the rotor in a simple manner and without additional components/structures.

The object is achieved by one or more of the features disclosed herein. Preferred designs are specified below and in the claims, each of which either individually or in combination can represent an aspect of the disclosure.

In the method according to the disclosure for producing a rotor for an electric machine, in particular a permanently excited synchronous machine, in which the rotor comprises the following components:

(i) an axially extending rotor shaft,

(ii) a ferromagnetic main body mounted on the rotor shaft or a row of ferromagnetic main bodies mounted axially successively on the rotor shaft,

(iii) a disc element mounted on the rotor shaft, which element connects axially to the main body or one of the main bodies, and

(iv) at least one permanent magnet, wherein at least one cavity is formed in the at least one main body and wherein the at least one permanent magnet is arranged in and glued into the at least one cavity, it is provided that the disc element is mounted on the rotor shaft by a jointing process and—where there is a plurality of base bodies successively—each main body is mounted on the rotor shaft by a jointing process and only after the corresponding main body is mounted is the at least one associated permanent magnet arranged in and glued into the at least one cavity of said mounted main body. In this way, the at least one permanent magnet can be glued cleanly and permanently. Additional components or structures for filling in adhesive (such as distribution channels and/or breakout openings) are not required, in particular for/in the disc element. The disc element seals the corresponding side of the axially adjacent main body in a fluid-tight manner from the outside with respect to the adhesive used solely because of its disc-like basic shape. Axially adjacent main bodies are then mounted on the rotor shaft in a fluid-tight manner with respect to the adhesive used.

It is provided in particular that the joining of the main body of the at least one of the main bodies onto the rotor shaft is a pressing and/or shrink-fitting onto the rotor shaft. A press connection is created between the rotor shaft and the other rotor components mentioned.

In the case of a joining that comprises shrink-fitting, it is preferably provided that the main body is heated for the shrink-fitting to a maximum temperature which is above a critical temperature of the at least one permanent magnet and/or a critical temperature of the adhesive used to glue the at least one permanent magnet. Such a shrink-fitting is only possible because it is first shrink-fitted onto the shaft and then glued. A particularly large excess is produced.

With regard to the joining, the same also applies to the disc element. Thus, according to a preferred embodiment, the joining of the disc element onto the rotor shaft is a pressing and/or shrink-fitting.

In addition to the disc element already mentioned, another disc element can of course also be provided. These can then be arranged at the two ends of the at least one main body in a very similar way to in DE 10 2008 027 758 A1.

In principle, the at least one main body can be formed from solid material. According to a further preferred embodiment, however, the at least one main body is formed by a laminated core having a plurality of laminations.

Alternatively or additionally, the disc element is designed as a balancing disc. In other words, the disc element has at least one balancing element for balancing the rotor.

In the rotor according to the disclosure for an electric machine, in particular a permanently excited synchronous machine (PSM), which comprises the following components:

an axially extending rotor shaft,

(ii) a ferromagnetic main body mounted on the rotor shaft or a row of ferromagnetic main bodies mounted axially successively on the rotor shaft,

(iii) a disc element mounted on the rotor shaft, which element connects axially to the main body or one of the main bodies, and

(iv) at least one permanent magnet,

wherein at least one cavity is formed in the at least one main body and the at least one permanent magnet is arranged in and glued into the at least one cavity, it is provided that the disc element is a disc element mounted on the rotor shaft by a jointing process, wherein the at least one main body is a main body mounted on the rotor shaft by a jointing process and the at least one permanent magnet is only glued in the at least one cavity of the mounted main body after the respective main body is mounted.

The disc element is designed as a cover which seals the corresponding side of the axially adjacent main body in a fluid-tight manner with respect to the adhesive used. In contrast to the rotor described in document DE 10 2008 027 758 A1, the disc element has neither distribution channels nor a breakout opening to the outside. Axially adjacent main bodies are then mounted on the rotor shaft in a fluid-tight manner with respect to the adhesive used.

It is advantageously provided that

a) the disc element is a disc element that is pressed and/or shrink-fitted onto the rotor shaft and/or that

b) at least one of the main bodies is a main body that is pressed and/or shrink-fitted onto the rotor shaft.

In the case of a main body shrink-fitted onto the rotor shaft, it is preferably provided that this shrink-fitted main body is a temporarily heated main body for shrink-fitting, in which the maximum temperature is above a critical temperature of the at least one permanent magnet and/or a critical temperature of the adhesive used to glue the at least one permanent magnet. An underlying shrink-fitting is only possible because it is first shrink-fitted onto the shaft and then glued.

In principle, the at least one main body can be formed from solid material. According to a further preferred embodiment, however, the at least one main body is formed by a laminated core having a plurality of laminations.

Alternatively or additionally, the disc element is designed as a balancing disc (or more specifically as a balancing plate). In other words, the disc element has at least one balancing element for balancing the rotor.

In the electric machine according to the disclosure, which has a rotor and a stator, it is provided that the rotor is designed as the aforementioned rotor. The electric machine (electric motor, generator or motor generator) is preferably a permanently excited synchronous machine.

### BRIEF DESCRIPTION OF THE DRAWINGS

In the following, the disclosure is explained by way of example with reference to the attached drawings using a preferred exemplary embodiment, wherein the features shown below can represent an aspect of the disclosure both individually and in combination, wherein:

FIG. 1: shows a rotor for an electric machine, which is designed according to a preferred embodiment of the disclosure.

### DETAILED DESCRIPTION

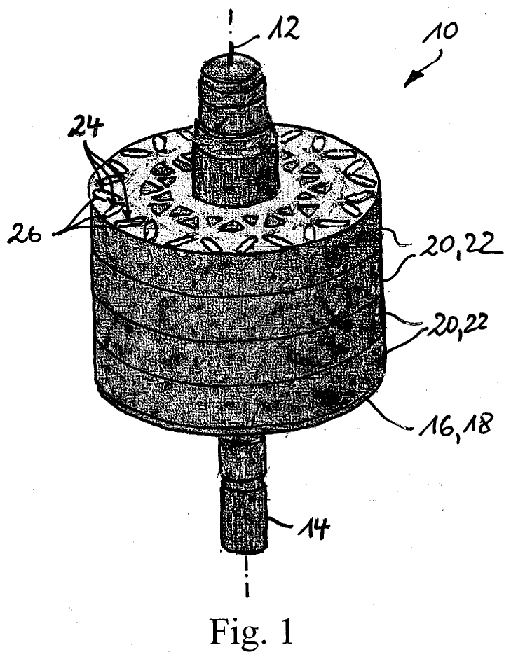

FIG. 1 shows a rotor 10 for an electric machine. The electric machine for which this type of rotor 10 is intended is a permanently excited synchronous machine (PSM). The rotor 10 comprises the following components: first, as the base of the rotor 10, a rotor shaft 14 that extends axially with respect to a longitudinal axis 12 of the rotor 10. Then a disc element 16 mounted on the rotor shaft 14, which in the example shown here is/forms a balancing disc 18. Furthermore, a row of ferromagnetic main bodies 20 mounted axially in direct succession on the rotor shaft 14, wherein the first main body of this row is connected axially directly to the disc element 16. Each of the ferromagnetic main bodies 20 of the rotor 10 is designed as a laminated core 22 with a plurality of laminations stacked on top of one another (not shown individually). Both the disc element 16 and each of the ferromagnetic main bodies 20 of the rotor 10 are joined to the rotor shaft 14, more precisely joined by an interference fit (press fit). As a rule, the corresponding parts 16, 20 are pressed and/or shrink-fitted onto the rotor shaft 14.

Circumferentially distributed cavities 24 for receiving permanent magnets 26 are formed in each of the base bodies 20, in each of which a permanent magnet 26 is also attached via an adhesive connection, i.e., glued. These cavities 24 are also referred to as magnet pockets or simply pockets. In addition to these cavities 24, other recesses or free spaces can also be formed in the main bodies 20 which are not provided for receiving permanent magnets 26.

During the manufacture of the rotor 10, the disc element 16 is first mounted on the rotor shaft 14 by means of a jointing process and each main body 20 is mounted successively on the rotor shaft 14 by means of a jointing process. Only after the mounting of the corresponding main body 20 are the associated permanent magnets arranged in and glued into the cavities 24 of this assembled main body 20. In this way, the permanent magnets 24 can be glued in place cleanly and permanently. Additional components or structures for filling in adhesive are not required. The joining of the disc element 16 and the main body 20 onto the rotor shaft 14 is a pressing and/or shrink-fitting onto the rotor shaft 14.

In other words, the main support of the overall rotor structure is the rotor shaft 14. First, the disc element 16 designed as a balancing disc 18 is joined onto the rotor shaft 14. The disc element 16 must completely cover the areas in which the permanent magnets 26 will later be positioned. Each main body 20 designed as a laminated core 22 is now individually joined and then provided with a permanent magnet 26 and adhesive. If an excess is provided for positioning the laminated cores 22 to the rotor shaft 14, the non-glued and not pre-assembled laminated cores 22 can be heated more, since the maximum permissible rotor temperature is usually limited by the permanent magnets 26 and the adhesive. This allows larger excesses to be achieved and implemented.

This method also prevents the adhesive from undesirably escaping from the laminated core 22, since the escape is blocked by the balancing disc 18 or the disc element 16. Another advantage is that curing of the adhesive can be omitted due to handling reasons. Corresponding process steps are therefore unnecessary. A workpiece carrier is also not required for the manufacture of the rotor 10. The corresponding components 16, 20 are mounted directly on the rotor shaft 14.

### LIST OF REFERENCE SYMBOLS

10 Rotor

12 Longitudinal axis

14 Rotor shaft

16 Disc element

18 Balancing disc

20 Main body

22 Laminated core

24 Cavity

26 Permanent magnet

1. A method for producing a rotor for an electric machine, wherein the rotor comprises following components:
an axially extending rotor shaft,
a ferromagnetic main body mounted on the rotor shaft or a row of ferromagnetic main bodies mounted axially successively on the rotor shaft,
a disc element mounted on the rotor shaft, which connects axially to the main body or one of the main bodies,
at least one permanent magnet, and
at least one cavity formed in the at least one main body and the at least one permanent magnet being arranged in and glued into the at least one cavity, the method comprising:
mounting the disc element on the rotor shaft by a jointing process;
mounting the or each said main body on the rotor shaft by a jointing process and only after the corresponding main body is mounted, arranging and gluing the at least one associated permanent magnet into the at least one cavity of said mounted main body.

2. The method according to claim 1, wherein the joining of the or each said main body onto the rotor shaft at least one of pressing or shrink-fitting the or each said main body onto the rotor shaft.

3. The method according to claim 2, the method further comprising heating the main body or each said main body for the shrink-fitting to a maximum temperature which is above a critical temperature of at least one of the at least one permanent magnet an adhesive used to glue the at least one permanent magnet.

4. The method according to claim 1, wherein the joining of the disc element onto the rotor shaft comprises at least one of pressing or shrink-fitting.

5. The method according to claim 1, wherein the main body or each said main body is formed by a laminated core with a plurality of laminations.

6. A rotor for an electric machine, the rotor comprising:
an axially extending rotor shaft;
a ferromagnetic main body mounted on the rotor shaft or a row of ferromagnetic main bodies mounted axially successively on the rotor shaft
a disc element mounted on the rotor shaft, which connects axially to the main body or one of the main bodies;
at least one permanent magnet;
at least one cavity formed in the at least one main body, and the at least one permanent magnet being arranged in and glued into the at least one cavity;
the disc element is mounted on the rotor shaft by a jointing process;
the or each said main body is mounted on the rotor shaft by a jointing process, and the at least one permanent magnet is glued into the at least one cavity of the or each said main body after the or each said main body is mounted.

7. The rotor according to claim 6, wherein
the disc element is at least one of pressed or shrink-fitted onto the rotor shaft.

8. The rotor according to claim 7, wherein the or each said main body that is shrink-fitted onto the rotor shaft is a temporarily heated main body for shrink-fitting, in which a maximum temperature is above a critical temperature of at least one of the at least one permanent magnet or an adhesive used to glue the at least one permanent magnet.

9. The rotor according to claim 7, wherein the or each said main body is formed by a laminated core with a plurality of laminations.

10. An electric machine, comprising:
the rotor according to claim 6; and
a stator.

11. The method according to claim 1, wherein the disc element is a balancing disc.

12. The rotor according to claim 6, wherein the or each said main body is at least one of pressed or shrink-fitted onto the rotor shaft.

13. The rotor according to claim 7, wherein the disc element is a balancing disc.

14. A method for producing a rotor for an electric machine, wherein the rotor comprises an axially extending rotor shaft, a ferromagnetic main body mounted on the rotor shaft, a disc element mounted on the rotor shaft, which connects axially to the main body, at least one permanent magnet, and at least one cavity formed in the main body and the at least one permanent magnet being arranged in and glued into the at least one cavity, the method comprising:
mounting the disc element on the rotor shaft;
mounting the main body on the rotor shaft by at least one of a shrink fit or a press fit; and
only after the main body is mounted, arranging and gluing the at least one associated permanent magnet into the at least one cavity of said mounted main body.

15. The method according to claim 14, the method further comprising heating the main body for the shrink-fitting to a maximum temperature which is above a critical temperature of at least one of the at least one permanent magnet or an adhesive used to glue the at least one permanent magnet.

16. The method according to claim 14, wherein the disc element is connected to the rotor shaft by at least one of pressing or shrink-fitting.

17. The method according to claim 14, wherein the main body is formed by a laminated core with a plurality of laminations.

18. The method of claim 14, wherein the main body comprises a row of ferromagnetic main bodies mounted axially successively on the rotor shaft.
